(19) United States
(12) Patent Application Publication
(10) Pub. No.: US 2015/0175187 A1
(43) Pub. Date: Jun. 25, 2015

(54) IMMOBILIZER FOR SHOPPING CARTS

(71) Applicant: Marcel HÖCKER, Herford (DE)

(72) Inventor: Marcel HÖCKER, Herford (DE)

(21) Appl. No.: 14/533,637

(22) Filed: Nov. 5, 2014

(30) Foreign Application Priority Data
Nov. 6, 2013 (DE) 202013009959.3

(51) Int. Cl. B62B 5/04

(52) U.S. Cl. CPC B62B 5/049

(57) ABSTRACT

The present invention relates to a roll-away-barrier for shopping carts which can be used in a simple manner (in particular blind without exactly being looked at). The roll-away barrier 1; 1a; 1b for shopping carts is mountable on the ground, in particular on the driving surface of a parking lot, wherein the roll-away barrier 1; 1a; 1bis round, in particular circular, features an arched, elevated edge 3, and has a recess b in the middle which can be driven over from all 360° sides by a roller of a shopping cart and is equipped to ensure a locking of one of the rollers of the shopping cart. The accessibility from all sides has the advantage that the shopping cart can be pushed onto the roll-away barrier from all sides and in turn can be pushed away again from the roll-away barrier from all sides.

The invention relates to a roll-away barrier for shopping carts, which roll-away barrier can be mounted on the parking lot of a supermarket. Such roll-away barriers usually have a shape which geometrically corresponds to a roller of the shopping cart. Furthermore the inventive roll-away barrier is round and has a bead-like elevation at the edges or a circumferential edge and a round recess or hollow in the center. A roller of the shopping cart can be driven into this recess, whereby it is locked and can no longer roll away.

According to the prior art there are already various embodiments of roll-away barriers for shopping carts or rollers which serve to block the rollers or wheels on the ground.

Reference is thus made to registered patent DE 201 02 928 U1, to patent application DE 42 42 556 A1, EP 0 672 571 A1, to registered patent DE 20 2007 011 131 U1, as well as patent GB 897 582 A.

The devices described in these documents have the disadvantage that a roller of a shopping cart must be positioned on it or in it in an entirely specific manner.

The object of the invention is to develop a roll-away barrier for shopping carts or rollers of the type described at the outset which facilitates the handling of the shopping cart.

This object is inventively achieved in that the profile of the roll-away barrier has a round shape with an equally elevated side edge and a hollow located in the middle. This roll-away barrier has a surface which can be driven onto regardless of the direction from all sides from 360° without prior alignment of the rollers. The accessibility from all sides has the advantage that the shopping cart can be pushed onto the roll-away barrier from all sides and also can be pushed away again in all directions from the roll-away barrier. As a result the roll-away barrier can be used in a simple manner (in particular blind, without being looked at precisely), especially with only one hand pushing the shopping cart, in order, for example, to be able to open a vehicle trunk with the other hand. Here the recess to receive the roller is provided so that any wedging function of the roll-away barrier is not required. The roll-away barrier can be emplaced in a simple manner on the ground and supplies a sufficient holding force to remain in position when the shopping cart is rolled onto it. The roll-away barrier does not at all have to be secured to the ground, but can be also carried along as a mobile variant in any automobile.

The inventive profile of the roll-away barrier enables an approach from all conceivable directions by the shopping cart and prevents any rolling away. Alignment of the wheels is not required. In contrast thereto the devices known in the prior art cannot be approached from all directions by the rollers of a shopping cart and thus cannot be used regardless of direction from all directions surrounding 360°. In these devices the rollers must also be aligned before use, since the rollers of a shopping cart usually can be swiveled in any direction around their own (vertical) axis.

According to one exemplary embodiment the elevated edge is constructed in a round and completely surrounding manner, in particular circular. As a result, shopping carts can not only be pushed from certain directions but in fact from any desired angle onto the roll-away barrier.

According to a preferred exemplary embodiment, the roll-away barrier is a mobile roll-away barrier which is erected by laying it on the ground without any fastening to the ground, in order to be able to receive a roller of the shopping cart. As a result a roll-away barrier can be provided anywhere, which can be at supermarkets at which no roll-away barriers are preinstalled. The roll-away barrier preferably has a substantially level bottom side on which the roll-away barrier can be laid down. Further preferred is a bottom side provided with a roughness or a structure which improves the adhesion of the roll-away barrier to the ground.

According to one exemplary embodiment the roll-away barrier has a substantially level bottom side or underside contact surface and is thereby installed to be driven over by a roller of a shopping cart without moving or displacing itself relative to a level ground surface. This makes possible easy handling. The roll-away barrier needs only to be quickly placed on the ground and the shopping cart can then be rolled onto it, even when the ground has a slight slope.

According to one exemplary embodiment the roll-away barrier has a lower edge which is round and preferably constructed in a completely surrounding manner, in particular circular. The roll-away barrier can thus be fixed stably on the ground, in particular also circumferentially preloaded. According to one variant such a lower edge is not necessarily provided. The lower edge can be omitted, if desired, in particular in a mobile variant of the roll-away barrier. The overall diameter of the roll-away barrier can be reduced by the lower edge or there can also be a rounding which can improve the surface feel and handling, especially by again lifting the roll-away barrier laid in the interim on the ground. The lower edge can also provide a border at which the roll-away barrier can again be more easily grabbed.

According to one exemplary embodiment the recess has a spherical-segment shape and is geometrically formed to correspond to a roller of a shopping cart, in particular arched in a concave manner with a uniform radius of curvature. The recess can thereby provide a receiving surface which positions the roller or the shopping cart in an exact, predetermined position.

According to one exemplary embodiment a mounting-opening for mounting the roll-away barrier on the ground is provided in the area of the recess, in particular in the center at a deepest point of the recess. As a result the roll-away barrier can be constructed circumferentially symmetric and be mounted at one position at which a mounting means or a fastening means is not in the path for a roller which is to be pushed onto the roll-away barrier.

According to an embodiment the roll-away barrier has a surrounding section between the elevated edge and a/the lower edge which arches in a concave manner. A ramp can thereby be formed over which the roller or the shopping cart can be pushed into the predefined position, or into the recess. The section can form a drive-up ramp. The ramp or the section can be aligned, e.g. at an angle of 20° to 30° with respect to the horizontal plane or the bottom side, in particular at an angle of 24° or 25°. A convex arch can thereby be guaranteed by a curvature radius in the range of, for example, 30 mm to 50 mm, in particular 40 mm. The width of the section or the ramp preferably amounts to between 20 mm and 30 mm, in particular approximately 26 mm. These dimensions or geometric properties can provide a roll-away barrier with a slight resistance against a roller and simultaneously also with a fixed foothold to the ground.

The surrounding section can also be characterized by varying curvature radii in individual sections. For example, the section can be comprised of three sub-sections each having a specific curvature radius. The curvature radius preferably lies below 10 mm, more preferably between 3 mm and 10 mm, in particular at 7.6 mm.

According to one exemplary embodiment the section has a curvature radius in the range of 35 mm to 45 mm, in particular 40 mm. A ramp can thereby be provided having a useful contour, in order to be able to push even heavily loaded shopping carts onto the roll-away barrier in a comparatively low-resistance manner.

According to one exemplary embodiment the roll-away barrier has a height in the range of 7 mm to 12 mm, preferably 8 mm to 11 mm, in particular 9 mm or 10 mm. A roll-away barrier can thereby be provided, in particular because of a comparatively flat shape, which forms only a slight resistance or only a small hindrance for the roller. In other words, with this height the roll-away barrier can be driven over in a simple manner and simultaneously supplies good holding for the roller. It has been seen that with these dimensions a good compromise can be ensured between hindrance to be overcome, and holding. Here the roll-away barrier can include a lower border or a lower edge which has a height in the range of 2 mm to 5 mm, in particular 3 mm or 4 mm, e.g. 3.77 mm. These dimensions facilitate the picking-up again of a roll-away barrier only temporarily placed on the ground.

According to one exemplary embodiment a deepest point of the recess lies higher than the lower edge of the roll-away barrier. As a result a preloading can be caused between the lower edge and the deepest point of the recess so that the roll-away barrier is mounted securely and in a rotation-free manner.

According to another exemplary embodiment the roll-away barrier is constructed from a plastic material, in particular polyethylene HD, or from metal, especially aluminum, alloyed steel, cast iron or hybrids therefrom, or from ceramic. Manufacturing can occur with all of these materials. It has been seen that all these materials are sufficiently robust and also sufficiently weather-resistant. A plastic material is preferably used, in particular polyethylene HD, wherein manufacturing preferably occurs using an injection molding process.

According to one exemplary embodiment the recess has a curvature radius in the range of 100 mm to 150 mm, preferably 115 mm to 135 mm, more preferably between 120 mm and 130 mm. As a result a receiving surface for the roller can be formed in which the roller can be securely supported.

According to another exemplary embodiment the roll-away barrier is a one-piece part, in particular made from a single material. As a result the roll-away barrier can be constructed especially robust or it can be manufactured in a simple manner or also be easily mounted.

According to a preferred exemplary embodiment the roll-away barrier has at least one groove or channel which preferably runs in the radial direction between the recess and the lower edge of the roll-away barrier, in particular with a gradient. In this way a draining of the recess can occur. The gradient amounts, for example, to 1° or 2° or even more degrees, in particular depending on the number or the width of the groove(s), so that water can run-off. The number of grooves can be freely selected to a great extent, e.g. between one and three or five or even more grooves.

According to one exemplary embodiment the roll-away barrier has at least one hole in the area of the recess, preferably a plurality of holes, which are so dimensioned that rain water can flow through the hole or holes. Preferably the holes are minimal in size, namely, e.g. in the range of 1 mm to 2 mm.

According to an exemplary embodiment the roll-away barrier is a formed part or an injection molded part, preferably an injection molded part made from plastic. As a result, a roll-away barrier with good haptic properties can be provided, in particular also a mobile roll-away barrier. Large quantities can thereby be manufactured in a cost-effective manner.

Further details of the invention will be described in the following Figures using schematically depicted exemplary embodiments.

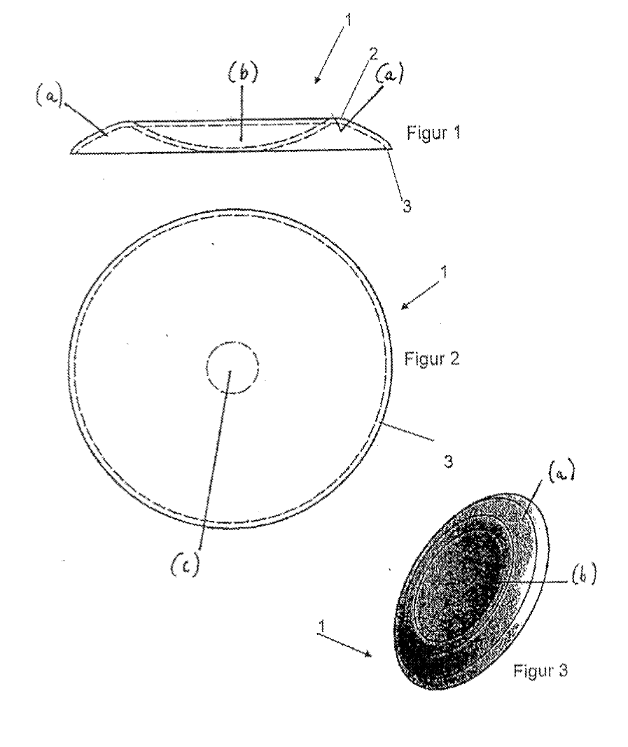

FIGS. 1 to 3 show a roll-away barrier according to a first exemplary embodiment of the present invention in various views;

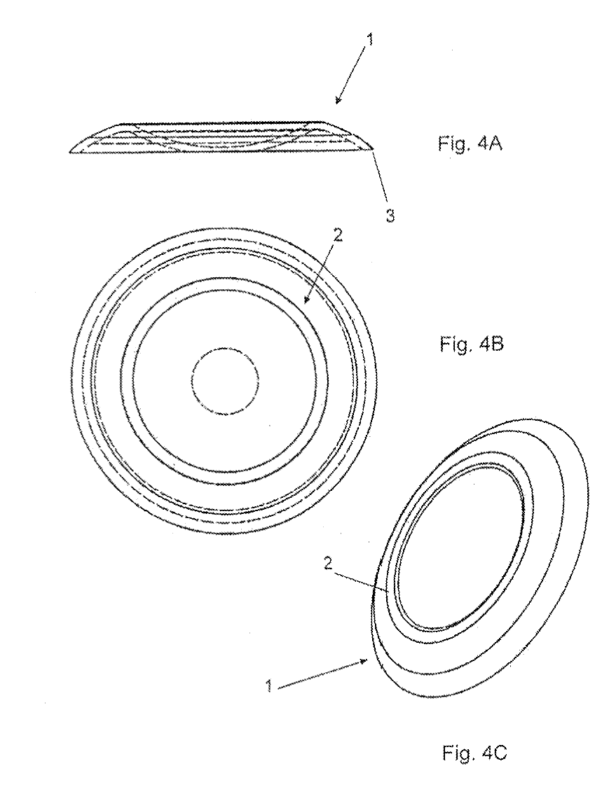

FIGS. 4A to 4C show the roll-away barrier shown in FIGS. 1 to 3 in further different views;

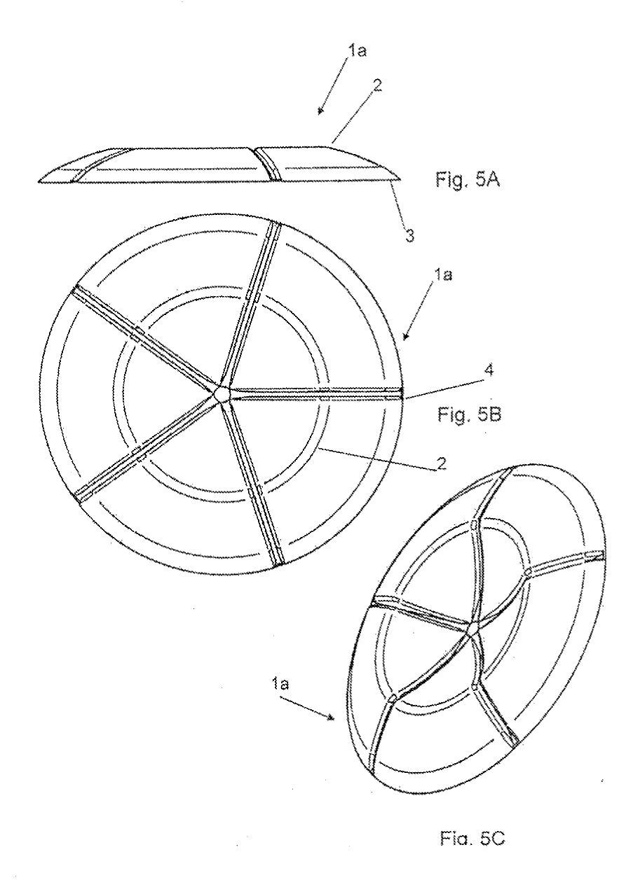

FIGS. 5A to 5C show a roll-away barrier according to a second exemplary embodiment of the present invention in different views;

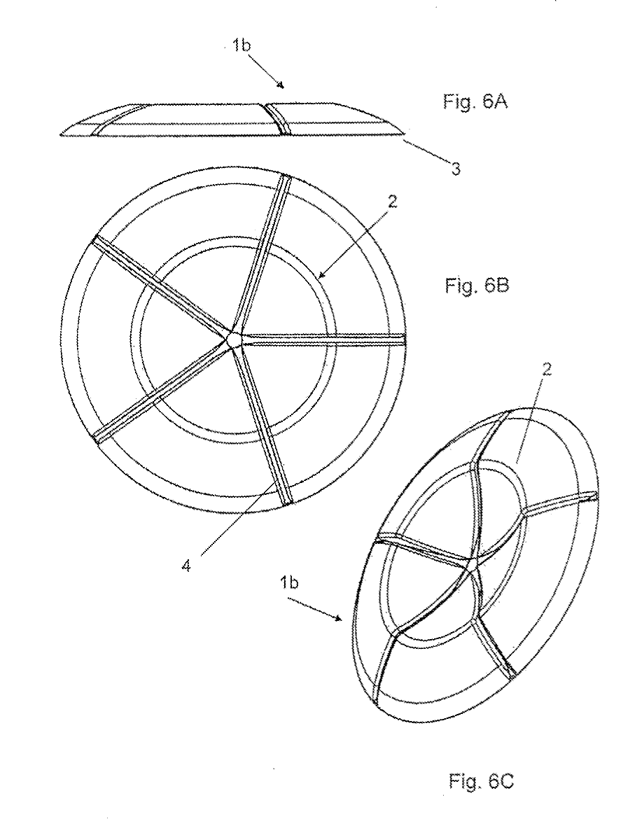

FIGS. 6A to 6C show a roll-away barrier according to a third exemplary embodiment of the present invention in different views.

Here FIGS. 1 to 6C show the following.

FIG. 1 shows a roll-away barrier 1 in profile in the side depiction as mounted horizontally on the parking lot. The roll-away barrier 1 is comprised of a surrounding side beading (a) as well as a round depression (b) in the center.

FIG. 2 shows a view from below of the bottom side of the roll-away barrier 1. In the center (c) a hole is available for mounting on the parking area, or, according to a variant, an adhesive edge (c) on a bottom side of the roll-away barrier. The roll-away barrier 1 can be adhered to the ground. If desired, the roll-away barrier 1 can also be used as a mobile roll-away barrier without there having to be a fastening to the ground.

FIG. 3 shows a perspective view of the front side of the roll-away barrier 1. The beading (a) and the recess (b) are recognizable in FIG. 3.

FIGS. 4A to 4C show the roll-away barrier 1 in a side depiction, in a view from above (plan view) as well as a perspective view of the front side.

FIGS. 5A to 5C show a roll-away barrier 1a in a side depiction, in a view from above (plan view) as well as in a perspective view of the front side, which in addition to the previously described components also features several grooves, slots, channels, or radial furrows 4 which extend in a star-shape towards the depression (b). Drainage can occur using these grooves 4, e.g. in the event that rainwater collects in the depression (b). The grooves 4 preferably have a gradient radially outward from the center.

FIGS. 6A to 6C show in a side depiction, in a view from above (plan view), as well as in a perspective view of a front side a roll-away barrier 1b which, in addition to the previously described components, also includes a plurality of grooves, slots, channels, or radial furrows 4 as described in conjunction with FIGS. 5A to 5C.

### REFERENCE NUMBER LIST

1 Roll-away barrier
1a Roll-away barrier according to a variant
1b Roll-away barrier according to a variant
2 Surrounding lower edge
3 Surrounding elevated edge
4 Groove, channel, slot, gutter, or radial furrow
   (a) Beading
   (b) Round recess
   (c) Hole, mounting opening or adhesive edge, in particular in the center on the bottom side of the roll-away barrier

1. Roll-away barrier (1; 1a; 1b) for shopping carts which is mountable on the ground, in particular on the driving surface of a parking area,
characterized in that the roll-away barrier (1; 1a; 1b) is round, in particular circular, includes an arched, elevated edge (3) and a recess (b) in the center which can be driven over 360° from all sides by a roller of a shopping cart and is equipped to ensure a locking of one of the rollers of the shopping cart.

2. Roll-away barrier according to claim 1, characterized in that the elevated edge (3) is completely surrounding and is formed round, in particular circular.

3. Roll-away barrier according to claim 1, characterized in that the recess (b) has a spherical-segment shape and is formed geometrically corresponding to a roller of a shopping cart, in particular arched in a concave manner with a uniform radius of curvature.

4. Roll-away barrier according to claim 1, characterized in that the recess (b) has a radius of curvature of 100 mm to 150 mm, preferably 115 mm to 135 mm, more preferably between 120 mm and 130 mm.

5. Roll-away barrier according to claim 1, characterized in that the roll-away barrier is a mobile roll-away barrier which is equipped to be placed on the ground without fastening to the ground in order to receive a roller of a shopping cart.

6. Roll-away barrier according to claim 5, characterized in that the roll-away barrier has a substantially level bottom side or an underside contact surface and is equipped to be run over by a roller of the shopping cart without moving or displacing itself with respect to a level ground area.

7. Roll-away barrier according to claim 1, characterized in that a mounting opening or an adhesive edge (c) for mounting the roll-away barrier on the ground is provided in the area of the recess (b), in particular at a deepest point of the recess (b).

8. Roll-away barrier according to claim 1, characterized in that the roll-away barrier has a surrounding section, which is arched in a concave manner, between the elevated edge (3) and a/the lower edge (2).

9. Roll-away barrier according to claim 8, characterized in that the section has a radius of curvature in the range of 35 mm to 45 mm, in particular 40 mm.

10. Roll-away barrier according to claim 1, characterized in that the roll-away barrier (1; 1a; 1b) has a height in the range of 7 mm to 12 mm, preferably 8 mm to 11 mm, in particular 9 mm or 10 mm.

11. Roll-away barrier according to claim 1, characterized in that a deepest point of the recess (b) lies higher than a/the lower edge (2) of the roll-away barrier.

12. Roll-away barrier according to claim 1, characterized in that the roll-away barrier is formed from a plastic material, in particular polyethylene HD, or from metal, in particular aluminum, alloyed steel, cast iron or hybrids thereof, or from ceramic.

13. Roll-away barrier according to claim 1, characterized in that the roll-away barrier is a one-piece part, in particular made from a single material.

14. Roll-away barrier according to claim 1, characterized in that the roll-away barrier has at least one groove (4) which preferably extends in a radial direction between the recess (b) and a/the lower edge (2) of the roll-away barrier, in particular with a gradient, or in that the roll-away barrier has in the area of the recess at least one hole, preferably a plurality of holes, which is/are so dimensioned that rainwater can flow through the hole or holes.

15. Roll-away barrier according to claim 1, characterized in that the roll-away barrier is a formed part or an injection molded part, preferably an injection molded part made from plastic.

16. Roll-away barrier according to claim 2, characterized in that the recess (b) has a spherical-segment shape and is formed geometrically corresponding to a roller of a shopping cart, in particular arched in a concave manner with a uniform radius of curvature.

17. Roll-away barrier according to claim 2, characterized in that the recess (b) has a radius of curvature of 100 mm to 150 mm, preferably 115 mm to 135 mm, more preferably between 120 mm and 130 mm.

18. Roll-away barrier according to claim 3, characterized in that the recess (b) has a radius of curvature of 100 mm to 150 mm, preferably 115 mm to 135 mm, more preferably between 120 mm and 130 mm.

19. Roll-away barrier according to claim 2, characterized in that the roll-away barrier is a mobile roll-away barrier which is equipped to be placed on the ground without fastening to the ground in order to receive a roller of a shopping cart.

20. Roll-away barrier according to claim 3, characterized in that the roll-away barrier is a mobile roll-away barrier which is equipped to be placed on the ground without fastening to the ground in order to receive a roller of a shopping cart.
